(19) United States
(12) Patent Application Publication
(10) Pub. No.: US 2004/0155392 A1
(43) Pub. Date: Aug. 12, 2004

(54) Laser welded viscous damper

(76) Inventors: David A. Doornbos, Manteno, IL (US); Christopher S. Marnell, Chicago Heights, IL (US)

Correspondence Address: PAUL F. DONOVAN, ILLINOIS TOOL WORKS INC., 3600 WEST LAKE AVENUE, GLENVIEW, IL, 60025, US

(21) Appl. No.: 10/359,869

(22) Filed: Feb. 6, 2003

(51) Int. Cl. F16F 1/04

(52) U.S. Cl. 267/290

(57) ABSTRACT

A damper includes a housing, a cover and a rotor. A portion of the rotor extends outwardly of the housing through the cover, and has a gear disposed thereon. The cover is joined to the housing by laser welding.

### FIELD OF THE INVENTION

The present invention pertains to high-precision movement dampers having a viscous fluid contained in a hermetically sealed chamber, and to methods for joining housing components to seal the chamber during manufacture of the dampers.

### BACKGROUND OF THE INVENTION

Movement dampers are used in various assemblies to control the movement of assembly components. For example, in furniture and cabinetry it is known to use dampers for controlling movement of a drawer or door in at least one direction. In automobiles, it is known to use dampers on glovebox and console doors, and the like.

A known damper design provides rotational resistance of a gear on a mechanism such as an automatic closer through driving engagement between the gear of the mechanism and a gear of the damper. Resistance to rotation of the gear on the damper, which is inherent in the structure of the damper, is thereby imparted to rotation of the mechanism gear, for controlling operation of the mechanism. Such damping devices frequently are referred to as gear dampers.

A gear damper of the type described is known to include a rotor rotatably held in a housing. An external gear is mounted on a shaft of the rotor projecting outwardly from the housing. Resistance to rotation of the rotor is provided in part by a viscous fluid contained in a chamber within the housing, through which viscous fluid the rotor must spin. For continued effective operation of the damper, the chamber defined by the housing must be hermetically sealed, to eliminate leakage of the viscous fluid. Any leakage adversely impacts damper performance.

It is known to form the housing from two components, including a first component defining the majority of the chamber for the viscous fluid, and a cover or cap for the housing. The cover defines an opening for the rotor shaft. During assembly of the damper, the viscous fluid is dispensed into the housing. The rotor is positioned in the housing, with the shaft of the rotor extending through the cover. An o-ring seals the opening in the cover around the rotor shaft, and the cover is connected to the housing in a manner intended to seal the connection against leakage of the damper fluid. Surfaces in the housing and in the cover are sealed against each other, to seal the chamber.

Known techniques for connecting the housing and cover include snap fits and ultrasonic welding. Snap fit components are relatively wide, and compress a thick seal therebetween. Frictional resistance to assembly is high, and snap fits provide less consistency in hermetic seal formation between the housing and cover. Failures occur if the components are not pressed together adequately.

Ultrasonic welding is a relatively violent process for the some-what delicate components in some gear dampers. When the ultrasonic horn contacts the assembly, surface marring can occur. Ultrasonic welding can produce weld flash and particulates when bonding the components, which can have undesirable effects on damper performance and longevity. Energy directors can be used advantageously in ultrasonic welding; however, preferred energy directors are triangular, with a sharp point, making the molding or other formation thereof difficult. Resulting damper torque performance varies from damper to damper, due to the inability to reliably control weld depth, and the dimensional distortion that can occur from the narrow engagement of the energy-directing component against its mating part. It is known to control an ultrasonic welding process by the depth of penetration, weld energy achieved, or time, none of which can ensure weld integrity or detect a potentially non-hermetic weld. As a result, visual inspection is required, and ultrasonically welded joints often also incorporate compressed seals at the joint to prevent leakage. This further increases damper size and cost.

There is a need in the art for a damper that is easier and less costly to assemble, and more reliable and consistent in operation than are known designs.

### SUMMARY OF THE INVENTION

The present invention provides a gear damper with a housing and cover secured to each other by laser welding.

The invention provides, in one form thereof, a damper with a housing having an opening, a cover over the opening and a rotor rotatably disposed in the housing. The rotor extends outwardly of the housing through the cover. A seal is provided between the cover and the rotor. The cover and the housing define a mutually engaging structure including a portion from the housing and a portion from the cover. One of the portions is transparent to a laser beam wavelength, and the other of the portions is absorbent to a laser beam wavelength for effecting a laser-beam-induced weld between the portions.

The invention provides, in another form thereof, a viscous gear damper with first and second components defining an enclosed chamber and a rotor having a first portion rotationally disposed in the chamber and a second portion extending outwardly of the camber. A gear is provided on the rotor. The first and second components are joined to each other by a laser-beam-induced weld.

In a further form thereof, the invention provides a method for assembling a damper with steps of providing a damper housing defining a chamber with an opening; providing a cover for the opening; providing a rotor having a first portion for rotation in the chamber and a second portion for extending outwardly of the housing; providing a fluid seal on the rotor; placing the first portion of the rotor in the chamber; sliding the cover onto the second portion of the rotor; positioning the cover against the seal and against the housing; and directing a laser beam at adjacent surfaces of the cover and the housing, thereby forming a weld between the cover and the housing with the laser beam.

An advantage of the present invention is providing a viscous damper that is easily and consistently assembled.

Another advantage of the present invention is providing a viscous damper that is reliable and sturdy, and that has tightened torque tolerances compared with known dampers.

A still further advantage of the present invention is providing an assembly process for viscous dampers that is easy to perform, reduces scrap and produces dampers that perform consistently.

Yet another advantage of the present invention is providing an assembly process for viscous dampers that is able to detect and reject a nonhermetically sealed joint between the damper housing and cover.

A yet further advantage of the present invention is providing a viscous damper having components that are easy to design and mold from thermoplastic materials.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a damper in accordance with the present invention;

FIG. 2 is a cross-sectional view of the damper shown in FIG. 1, taken on line 2-2 of FIG. 1; and

FIG. 3 is an enlarged view of a portion of the cross-sectional view shown in FIG. 2, illustrating a step during assembly of a damper.

Before the embodiments of the invention are explained in detail, it is to be understood that the invention is not limited in its application to the details of construction and the arrangements of the components set forth in the following description, or illustrated in the drawings. The invention is capable of other embodiments and of being practiced or being carried out in various ways. Also, it is understood that the phraseology and terminology used herein are for the purpose of description and should not be regarded as limiting. The use herein of “including” and “comprising”, and variations thereof, is meant to encompass the items listed thereafter and equivalents thereof, as well as additional items and equivalents thereof.

### DETAILED DESCRIPTION OF THE PREFERRED EMBODIMENT

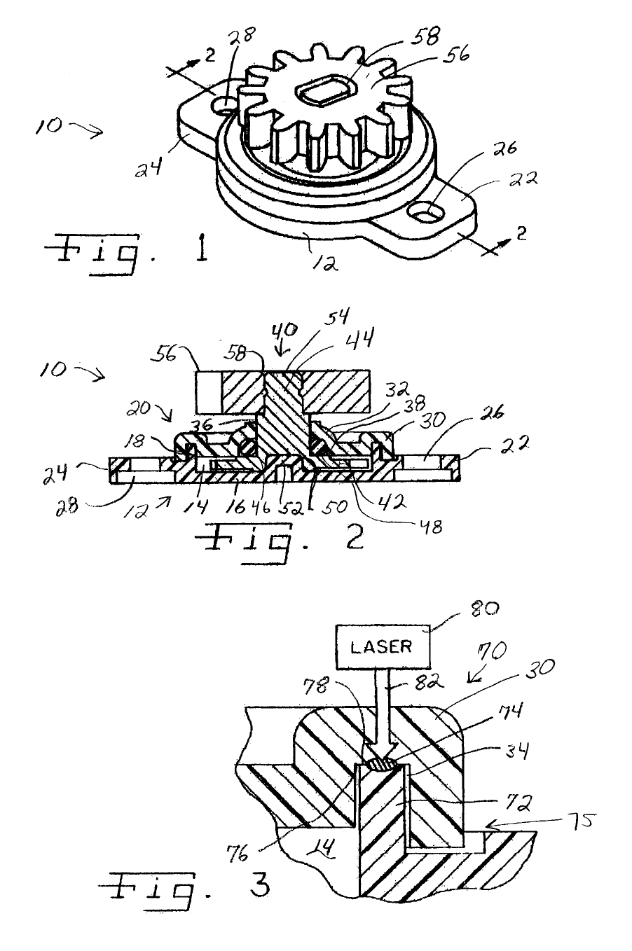

Referring now more specifically to the drawings, and to FIG. 1 in particular, numeral 10 designates a damper of the present invention, which can be used for controlling the movement of a device (not shown), which maybe a drawer slide, a door closer or the like in appliances, furniture, automobiles or other devices. It is anticipated that damper 10 of the present invention will have a wide range of uses and applications, and should not be interpreted as being limited to the few applications and uses provided as examples herein.

Damper 10 includes a housing 12 defining a chamber 14 having a closed bottom or first end 16, a substantially cylindrical side 18 and an open top or second end. A cover 20 is provided as a closure for the open top of housing 12. Housing 12 and cover 20 thereby are first and second components defining an enclosed volume therebetween for chamber 14. One or more tabs or fixtures 22, 24 can be provided on housing 12, two such fixtures 22, 24 being shown in the drawings. Fixtures 22, 24 are provided with holes 26, 28 for receiving screws, bolts or other fasteners (not shown) to secure housing 12 as desired in a device (not shown). Those skilled in the art will understand readily that other structure, devices and attaching systems can be used.

Cover 20 defines an annular outer rim 30 and a central dome 32. Rim 30 defines an annular channel 34 (FIG. 3) adapted, arranged and sized to receive therein the open end of housing side 12. Central dome 32 surrounds a central opening or hole 36 in cover 20 and provides a bowl-like interior region 38.

A rotor 40 is disposed partially within chamber 14, and is rotatable about its own longitudinal axis. Rotor 40 includes a first portion 42 substantially contained within chamber 14, and a second portion 44 extending outwardly from housing 12, through hole 36 in cover 20. Rotation of rotor 40 in chamber 14 is retarded or inhibited by operation of a damping component in chamber 14. As those skilled in the art will understand readily, the damping component may include a damping fluid contained within chamber 14, with the viscosity of the fluid and the gap between components of rotor 40 and chamber 14 determining the torque performance of damper 10. First portion 42 is cooperatively shaped in association with chamber 14 to experience the desired damping effect to the rotation thereof from the resistance provided from the fluid contained in chamber 14. First portion 42 of rotor 40 is of greater diameter than is second portion 44, thereby defining an L-shaped ledge 46 at the transition from first portion 42 to second portion 44. An o-ring seal 48 is disposed around second portion 44, substantially on ledge 46 and within bowl-like region 38. In the assembled damper 10, o-ring seal 48 provides a fluid-tight seal against both rotor 40 and dome 32 so that damping fluid is contained within chamber 14 and does not leak from hole 36.

First portion 42 fits closely within chamber 14, and may be of several configurations to achieve the desired damping effect. As shown, first portion 42 is substantially plate-like, with a central cavity 50 formed therein opposite the side from which second portion 44 extends. Bottom 16 of housing 12 includes a projection 52 extending inwardly in chamber 14. Projection 52 is received in cavity 50 to stabilize the position and rotation of rotor 40 in chamber 14.

Second portion 44 is configured substantially as a short shaft projecting from housing 12 in the assembled damper 10, and includes a distal end 54. Advantageously, rotor 40 is formed as a one-piece, monolithic structure including first portion 42 and second portion 44. Distal end 54 is configured to receive thereon a damper gear 56 having an axial aperture 58.

Referring now to FIG. 3, an enlarged view of an engaging structure 70 is shown, by which housing 12 and cover 20 are joined to each other to form a fluid tight seal. Engaging structure 70 is formed from portions of housing 12 and cover 20, and includes channel 34 in cover 20 and an end portion 72 of side 18 of housing 12. End portion 72 is received in channel 34 and secured thereto by a laser-beam-induced weld 74. Weld 74 is formed in a continuous band within channel 34 between mating surfaces of end portion 72 and cover 20. Specifically, channel 34 includes a substantially flat channel bottom 76, and end portion 72 has a substantially flat end edge 78 disposed in confronting relationship as damper 10 is assembled. Although weld 74 is formed within channel 34 as shown, a similar weld could be provided at location 75 where the housing 12 and cover 20 mate together. Alternatively, for an even greater bonding affect, two welds could be provided.

Weld 74 is formed by transmission laser welding. A laser 80 emits a laser beam 82 which is absorbed by material of the confronting surfaces of channel bottom 76 and end edge 78, to melt a layer of the material causing the parts to fuse together. Advantageously, at least rim 30 of cover 20 is provided of material transparent to the wavelength of laser beam 82, so that laser beam 82 passes through or penetrates rim 30 to reach end portion 72. Clear polycarbonate is a suitable material for rim 30, and may be used for all of cover 20 to facilitate manufacture of cover 20. At least end portion 72 of housing 12 is absorbent of the wavelength of laser beam 82, so that localized heating occurs at end edge 78 sufficient to soften or melt material to cause cover 20 and end portion 72 to fuse together. Plastic such as polycarbonate filled with carbon black is suitable for end portion 72, and for ease of manufacturing housing 12, carbon black filled polycarbonate can be used for all of housing 12.

During assembly of damper 10, o-ring seal 48 is placed on rotor 40, which is then inserted through hole 36 in cover 20. Damping fluid is dispensed into chamber 14, and rotor 40 is positioned therein. Cover 20 and housing 12 are urged together such that o-ring seal 48 seats against dome 32 and rotor 40, and end edge 78 is placed against channel bottom 76. Laser 80 is activated to direct laser beam 82 through rim 30 and against end edge 78. Localized heating occurs, resulting in the fusion of end edge 78 to channel bottom 76. Laser beam 82 is caused to move around damper 10, following rim 30, either by moving a fixture holding damper 10 or by moving laser 80, so that a continuous laser-beam-induced weld is formed between channel bottom 76 and end edge 78.

The substantially flat surfaces of end edge 78 and channel bottom 76 are easy to manufacture, and provide a more dimensionally stable assembly then the narrow energy directing components required for ultrasonic welding. Because a flat target surface is provided for laser beam 82, the target is accurately acquired, and weld depth is controlled more precisely than by ultrasonic welding. Each of these promotes dimensionally consistent assembly of dampers 10, thereby improving consistent torque performance among different dampers 10.

Transmission laser welding can be controlled by measuring the temperature achieved as the beam creates the weld. Contamination in the weld area, part irregularities affecting the weld, or other defects potentially causing a non-hermetic seal will be evidenced by temperature spikes either above or below the target temperature. The welding process can reject automatically any damper 10 experiencing such temperature spikes, with the added ability to designate on the rejected damper 10 the area of potential defect for later inspection or analysis.

The present invention provides high precision viscous damper with a superior hermetic seal. The manufacturing and assembly processes promote efficiencies reducing costs.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A damper comprising:
a housing having an opening;
a cover over said opening;
a rotor rotatably disposed in said housing, said rotor extending outwardly of said housing through said cover;
a seal between said cover and said rotor; and
said cover and said housing defining a mutually engaging structure including a portion from said housing and a portion from said cover, one of said portions being transparent to a laser beam wavelength and the other of said portions being absorbent to a laser beam wavelength for effecting a laser-beam induced weld between said portions.

2. The damper of claim 1, said cover being transparent to a laser beam.

3. The damper of claim 2, said cover having a rim defining a channel, and said housing including an end disposed in said channel.

4. The damper of claim 3, said channel having a substantially flat channel bottom, and said housing end having a substantially flat end edge.

5. The damper of claim 4, said cover defining a dome, and said seal including an o-ring on said rotor and seated in said dome.

6. The damper of claim 1, said cover having a rim defining a channel, and said housing including an end disposed in said channel.

7. The damper of claim 6, said channel having a substantially flat channel bottom, and said housing end having a substantially flat end edge.

8. The damper of claim 1, said cover defining a dome, and said seal including an o-ring on said rotor and seated in said dome.

9. The damper of claim 1, said housing being of carbon black filled polycarbonate.

10. A viscous gear damper comprising:
first and second components defining an enclosed chamber;
a rotor having a first portion rotationally disposed in said chamber and a second portion extending outwardly from said chamber;
a gear disposed on said second portion of said rotor; and
said first and second components being joined to each other by a laser-beam-induced weld.

11. The viscous gear damper of claim 10, one of said components being of material transparent to a laser beam wavelength.

12. The viscous gear damper of claim 10, one of said components being of material for absorbing a laser beam wavelength.

13. The viscous gear damper of claim 12 said one of said components being of carbon black filled polycarbonate.

14. The viscous gear damper of claim 13, including an O-ring on said rotor, between said rotor and one of said components.

15. The viscous gear damper of claim 10, wherein one of said components is comprised of polycarbonate filled with carbon black, and the other of said components is comprised of clear polycarbonate.

16. A method for assembling a damper comprising steps of:
providing a damper housing defining a chamber with an opening;
providing a cover for the opening;
providing a rotor having a first portion for rotation in the chamber and a second portion for extending outwardly of the housing;
providing a fluid seal on the rotor;
placing the first portion of the rotor in the chamber;
sliding the cover onto the second portion of the rotor and positioning the cover against the seal and against the housing; and
directing a laser beam at adjacent surfaces of the cover and the housing and forming a weld between the cover and the housing with the laser beam.

17. The method of claim 16, including;
providing the cover of material transparent to the laser beam; and
directing the laser beam through the cover to the adjacent surfaces of the cover and the housing.

18. The method of claim 17, including providing the housing of polycarbonate filled with carbon black.

19. The method of claim 18, including a step of dispensing damping fluid into the chamber.

20. The method of claim 16, including dispensing damping fluid into the chamber.
